(19) United States
(12) Patent Application Publication
(10) Pub. No.: US 2021/0027266 A1
(43) Pub. Date: Jan. 28, 2021

(54) Queue-Swapping

(71) Applicant: Xin Huang, Redmond, WA (US)

(72) Inventor: Xin Huang, Redmond, WA (US)

(21) Appl. No.: 16/522,558

(22) Filed: Jul. 25, 2019

(51) Int. Cl. G06Q 20/20; G06Q 30/02

(52) U.S. Cl. CPC G06Q 20/20; G06Q 30/0238

(57) ABSTRACT

Techniques to provide a queue-swapping system and method are described. In one implementation, queue-swapping may integrate with a queue management or point of sale (POS) system and perform steps comprising identifying parties as queue-swapping candidates, receiving inputs comprising values offered in exchange for queue-swapping, identifying queue-swapping matches by comparing input values, filtering or ranking the matches, and outputting recommendations for optimal queue arrangements. Queue-swapping may integrate into a queue management or point of sale (POS) system, freeing up overloaded systems, reducing lag times, and improving efficiency and functionality of the systems.

### FIELD

This disclosure relates generally to systems and methods for queue-swapping.

### BACKGROUND

Physical or virtual queues may form in various locations, for example, in businesses or public institutions, on the street, over the phone, or on the Internet. Many establishments face an ongoing challenge to properly manage queues. Queue management is crucial, as prolonged queues may cause a waiting party to become angry or to seek a competitor's services, harming an establishment's business or goodwill. Improperly managed queues may also pose risks to public safety.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

Establishments, such as businesses or public institutions, have an interest in maintaining a steady flow of customers and reducing wait times. Limited time, staff, and resources make it unfeasible for workers to attend to parties waiting in physical or virtual queues, who may be in distant geographic locations. Conventional methods have attempted to enhance queue efficiencies by providing estimated wait times or alerts to parties through a display screen, a vibrating device, a phone call, a text message, or an email, for example. However, conventional methods provide no mechanism to facilitate networked exchanges between actual waiting parties, who may provide valuable input for optimizing queue management. Lack of such a mechanism has contributed to a prevalence of prolonged and inefficient queues, lost profits, and decreased customer satisfaction.

Disclosed, among other things, are techniques to allow for queue-swapping, which may comprise a system and method to facilitate networked exchanges between waiting parties to optimize efficiency of a physical or virtual queue. In one implementation, queue-swapping may perform steps of identifying parties as queue-swapping candidates and receiving inputs from the candidates, whereby the inputs may comprise values representing an amount of money, credits, or points, for example, for which a candidate is willing to surrender its queue position in exchange for another queue position, an amount that a candidate is willing to pay in exchange for another queue position, or rewards offered by an establishment for parties that engage in queue-swapping, for example. Queue-swapping may also perform steps of identifying queue-swapping matches by comparing input values from different candidates to extract compatible values, filtering or ranking the matches, and outputting recommendations for optimal queue arrangements.

Queue-swapping may integrate into a queue management or point of sale (POS) system, freeing up overloaded systems, reducing lag times, and improving efficiency and functionality of the systems. Integration of queue-swapping techniques may yield additional practical benefits such as easing queue traffic flow, decreasing queue lengths, enhancing profitability or goodwill, improving public safety, and increasing customer satisfaction.

### BRIEF DESCRIPTION OF THE DRAWINGS

The present description may be better understood from the following detailed description read in light of the appended drawings, wherein:

FIG. 1 is a diagram illustrating a queue-swapping system operable to facilitate networked exchanges between waiting parties to optimize efficiency of a physical or virtual queue.

FIG. 2 illustrates a flow chart with a set of operations for identifying queue-swapping candidates, according to one implementation.

FIG. 3 illustrates a flow chart with a set of operations for determining an optimal queue-swapping arrangement and executing a queue-swapping process, according to one implementation.

FIG. 4 is a block diagram with components that may be used in a queue-swapping system, according to one implementation.

FIG. 5 is an example of a graphical user interface which may be used for queue-swapping, according to one implementation.

FIG. 6 is an example of a graphical user interface which may be used for queue-swapping, according to one implementation.

FIG. 7 is a block diagram illustrating an example of a system capable of supporting a queue-swapping method, according to one implementation.

FIG. 8 is a component diagram of a computing device which may support a queue-swapping method, according to one implementation.

### DETAILED DESCRIPTION

A more particular description of certain implementations of Queue-Swapping may be had by references to the implementations shown in the drawings that form a part of this specification, in which like numerals represent like objects.

The illustrated operations in the description show certain events occurring in a certain order. One skilled in the art will recognize that certain operations may be performed in a different order, modified or removed. Moreover, steps may be added to the described logic and still conform to the described implementations.

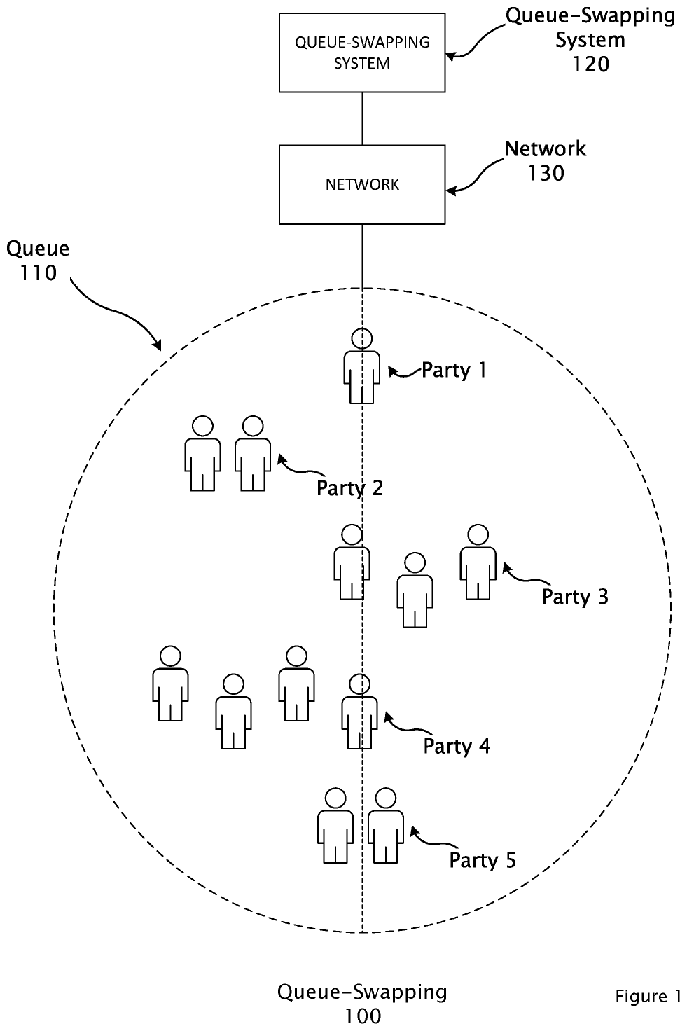

FIG. 1 is a diagram illustrating a queue-swapping system operable to facilitate networked exchanges between waiting parties to optimize efficiency of a physical or virtual queue. In one implementation, an establishment, such as a restaurant or government agency, may receive parties in a Queue 110. The waiting parties may be designated as Party 1, Party 2, Party 3, Party 4, and Party 5, for example. The waiting parties may be in a physical queue, such as a waiting line, in a virtual queue, or in both, and may be dispersed across different geographic locations.

Queue-Swapping System 120 may utilize Network 130 to facilitate exchanges between any or all of Party 1, Party 2, Party 3, Party 4, or Party 5. Exchanges may include communications to execute queue-swapping transactions, for example. In one implementation, Queue-Swapping System 120 may receive inputs from waiting parties over Network 130, whereby the inputs may comprise values representing an amount of money, credits, or points, for example, for which a candidate is willing to surrender its queue position in exchange for another candidate's position, an amount that a candidate is willing to pay in exchange for another candidate's position, or an amount offered by an establishment for parties that engage in queue-swapping, for example. A person skilled in the art will understand that an amount exchanged may comprise any form of consideration, including rewards or virtual money. Queue-Swapping System 120 may identify matches by comparing input values from different candidates to find compatible values. The system may filter or rank the matches and output recommendations for optimal queue arrangements. Queue-Swapping 120 may integrate into a queue management or point of sale (POS) system, freeing up overloaded systems, reducing lag times, and improving efficiency and functionality.

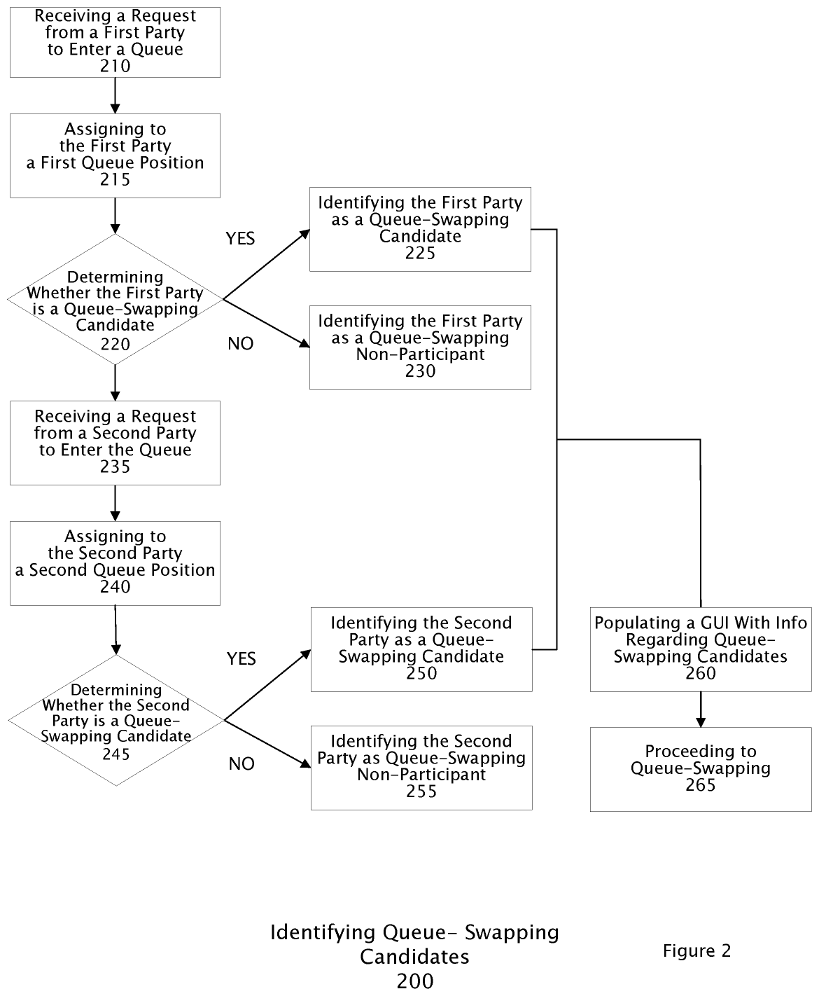

FIG. 2 illustrates a flow chart with a set of operations for Identifying Queue-Swapping Candidates 200, according to one implementation. Various implementations of queue-swapping techniques may include computer-readable storage media containing sets of instructions to cause one or more processors to perform methods, variations of the methods, and other operations described herein.

At Receiving a Request from a First Party to Enter a Queue 210, Queue-Swapping System 120 may receive a name of a party that wishes to enter the queue, or another identifier, such as a phone number, email address, or account number. Queue-Swapping System 120 may obscure the party name or assign a pseudonym to protect privacy.

At Assigning to the First Party a Queue Position 215, the system may assign the first party to a queue position, for example, chronologically or on a first-come, first-served basis. For example, if Party 1 has an earliest reservation or arrival time, the system may assign Party 1 to position 1 in the queue. The system may also assign a party to a queue position using any other method, for example, based on factors such as party size, service needs, available staff, or membership status.

At Determining Whether the First Party is a Queue-Swapping Candidate 220, the system may send a request over the Network 130 to inquire whether the first party would like to designate itself as a queue-swapping candidate. For example, the system may display a queue-swapping button on a touch-screen computer tablet, or it may send an invitation openable on a mobile device. If YES, the system may proceed to Identifying the First Party as a Queue-Swapping Candidate 225. If NO, then the system may proceed to Identifying the First Party as a Queue-Swapping Non-Participant 230.

At Receiving a Request from a Second Party to Enter the Queue 235, the Queue-Swapping System 120 may receive identification of a second, or subsequent, party that wants to enter the queue. At Assigning to the Second Party a Second Queue Position 240, the system may assign the second party to a queue position. At Determining Whether the Second Party is a Queue-Swapping Candidate 245, the system may send a request over the network to inquire whether the second party would like to designate itself as a queue-swapping candidate. If YES, then the system may proceed to Identifying the Second Party as a Queue-Swapping Candidate 250. If NO, it may proceed to Identifying the Second Party as a Queue-Swapping Non-Participant 255.

In another implementation, the system may detect whether a party should serve as a queue-swapping candidate by applying weighted values representing queue-swapping optimization factors. Queue-swapping optimization factors may include a length of a queue, a time constraint, or a party's queue-swapping history.

At Populating a GUI With Info Regarding Queue-Swapping Candidates 260, the system may populate a graphical user interface with names of the queue-swapping candidates before Proceeding to Queue-Swapping 265.

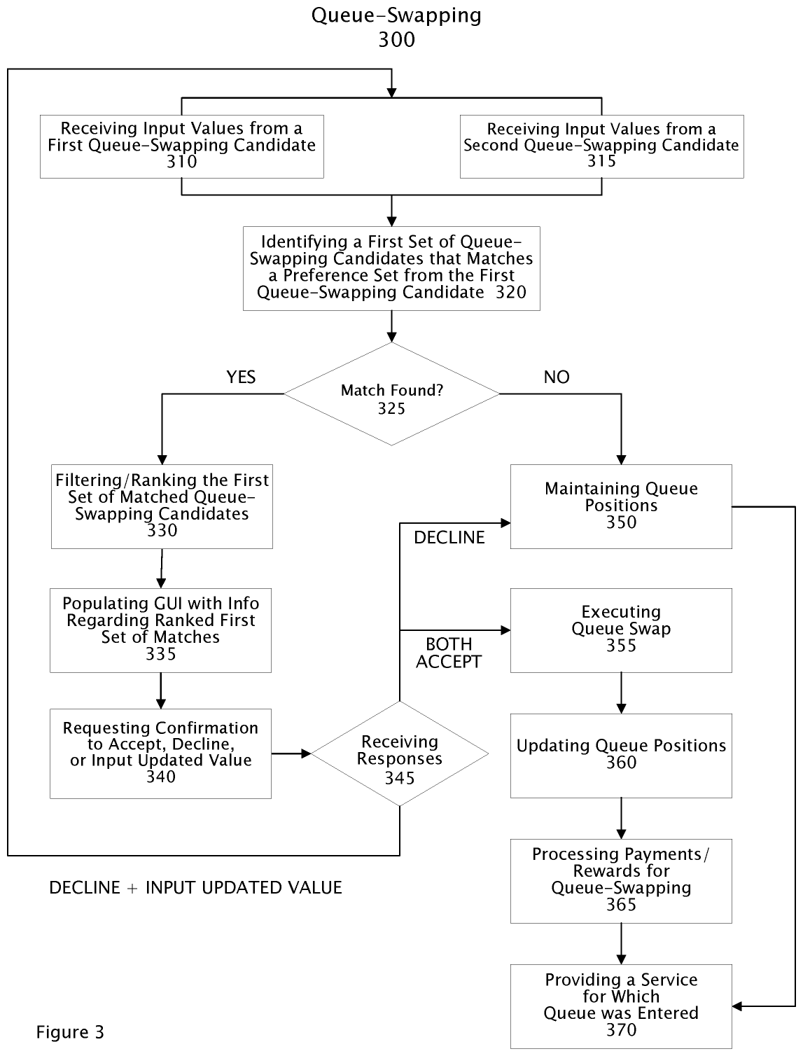

FIG. 3 illustrates a flow chart with a set of operations for determining an optimal queue-swapping arrangement and executing a queue-swapping process, according to one implementation.

At Receiving Inputs from a First Queue-Swapping Candidate 310 and Receiving Inputs from a Second Queue-Swapping Candidate 315, Queue-Swapping System 120 may receive inputs representing values such as an amount of money, credits, or points for which a candidate is willing to surrender its queue position in exchange for another candidate's position, an amount that a candidate is willing to pay in exchange for another candidate's position, or rewards offered by an establishment for parties that engage in queue-swapping, for example. In one implementation, the system may include a step of populating the GUI with input values from the first and second queue-swapping candidates.

At Identifying a First Set of Queue-Swapping Candidates that Matches a Preference Set from the First Queue-Swapping Candidate 320, the system may compare the input values from the first queue-swapping candidate with the input values from other queue-swapping candidates to find compatible or matching values. At Match Found? 325, the system may link candidates with compatible or matching values. For example, a match may be found if the first candidate, who may be initially assigned to queue position 2, inputs a ≥15-dollar value bid to surrender its queue position for another candidate's position, with an expiration of ≤5:00 minutes, and the second, or subsequent, candidate who may be initially assigned to position 5, for example, inputs a ≤15-dollar bid for either queue position 1 or 2, with an offer expiration time of 15:00 minutes. If YES at step 325, a match is found, and the system may perform Filtering/Ranking the First Set of Matched Queue-Swapping Candidates 330. In one implementation, the system may apply weighted values representing queue-swapping optimization factors. For example, it may assign a higher ranking to a candidate who has a highest bid or an earliest bid expiration time. In another implementation, a candidate may apply a personalized set of filters. At Populating GUI with Info Regarding Ranked First Set of Matches 335, the system may display a set of matched queue-swapping candidates in a ranked order.

If NO at step 325, there is no match found, and the system may proceed to Maintaining Queue Positions 350 and displaying real-time updates, for example, expiration times, on a queue-swapping graphical user interface.

At Requesting Confirmation to Accept, Decline, or Input Updated Value 340, the system may request the matched first and second queue-swapping candidates to either accept a swap based on the match, to decline a swap and maintain queue positions, or to decline and input an updated value, for example, a higher bid or later expiration time.

At Receiving Responses 345, the system may process the answers received by the queue-swapping candidates. If a candidate declines, then the system may proceed to Maintaining Queue Positions 350. If the candidate declines and selects to input an updated value, the system may return to Receiving an Input Value from a First Queue-Swapping Candidate 310 or Receiving an Input Value from a Second Queue-Swapping Candidate 315, depending on which candidate made the selection, and the system may update the input value. If a candidate accepts the confirmation to queue-swap based on the match, then the system may proceed to Executing Queue-Swap 350. The system may proceed to Updating Queue Positions 360 of the parties that engaged in the swap, as well as other positions in the queue, if necessary. The system may proceed to Processing Payments/Rewards for Queue-Swapping 365 and Providing a Service for Which Queue was Entered 370. The service may comprise provision of food, provision of beverages, provision of entertainment, provision of social services, provision of medical care, provision of technical support, or provision of customer service, for example, bringing food to a party's table, or another service.

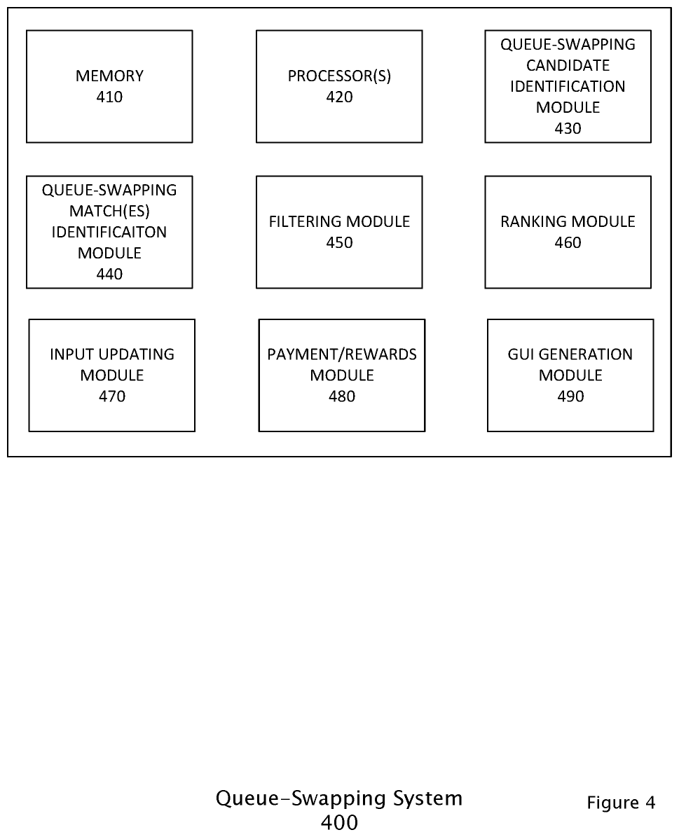

FIG. 4 is a block diagram with components that may be used in a queue-swapping system, according to one implementation. Queue-Swapping System 400 may include Memory 410, one or more Processor(s) 420, Queue-Swapping Candidate Identification Module 430, Queue-Swapping Match(es) Identification Module 440, Filtering Module, Ranking Module 460, Input Updating Module, Payment/Rewards Module 480, and Graphical User Interface (GUI) Generation Module 490.

Memory 410 may be any device, mechanism, or populated data structure used for storing information. Memory 410 may be used to store instructions for running one or more applications or modules on Processor(s) 420. For example, Memory 410 may be used in one or more implementations to house all or some of the instructions needed to execute a function of Queue-Swapping Candidate Identification Module 430, Queue-Swapping Match(es) Identification Module 440, Filtering Module 450, Ranking Module 460, Input Updating Module, Payment/Rewards Module 480, or Graphical User Interface (GUI) Generation Module 490.

Queue-Swapping Candidate Identification Module 430 may be operable to identify a set of parties that are available to serve as queue-swapping candidates. The Queue-Swapping Candidate Identification Module 430 may be further operable to monitor a preference set of candidates and notify a first candidate of any changes to the set of candidates or input values, for example. Queue-Swapping Match(es) Identification Module 440 may be operable to compare input values from different queue-swapping candidates to find compatible or matching values. Filtering Module 450 and Ranking Module 460 may be operable to filter and rank candidates, for example, by applying weighted values representing queue-swapping optimization factors. Input Updating Module 470 may be operable to update input values, for example, updated bid amounts or expiration times in Queue-Swapping System 400. Payment/Rewards Module 480 may be operable to process or facilitate communications regarding queue-swapping transactions or to process exchange of payments or rewards. Graphical User Interface (GUI) Generation Module 490 may be operable to generate a GUI screen with queue-swapping information or to facilitate communications between parties, queue-swapping candidates, or establishments, for example.

Queue-Swapping System 400 may include or access a database including information regarding queue-swapping candidates or other information. Queue-Swapping Candidate Identification Module 430 may access the database, or another database, and use the data to filter or rank queue-swapping candidates. In another implementation, Queue-Swapping System 400 may also include an application programming interface (API) server, which may be operable to receive information that identifies a subset of parties that may be available to serve as queue-swapping candidates.

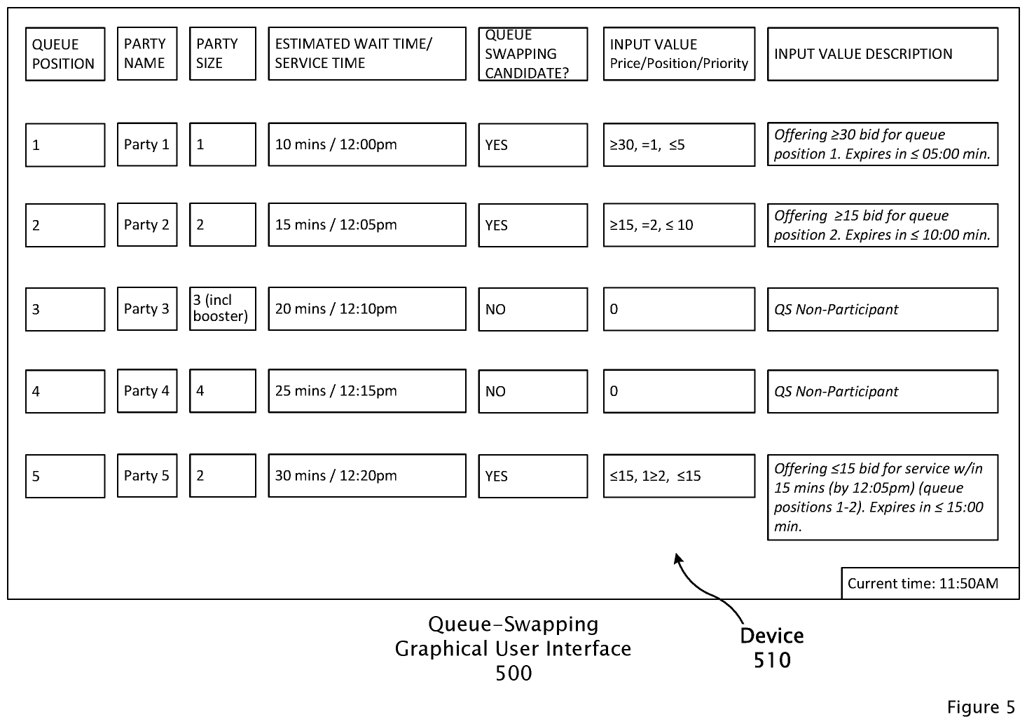

FIG. 5 is an example of a graphical user interface which may be used for queue-swapping, according to one implementation. Queue-Swapping Graphical User Interface 500 may be displayed on Device 510, such as a desktop computer, laptop computer, tablet computer, mobile phone, or another device. Graphical User Interface 500 may display fields indicating a queue position, a party name, a party size, an estimated wait time or service time, input values such as a bid amount, queue position, or expiration time, or an input value description, for example.

In one implementation, if nobody accepts a candidate's bid within a certain time, the bid may increase. In another implementation, a party waiting in a queue may input a value indicating a willingness to surrender or swap their queue position for any amount. In another implementation, an establishment managing a queue or a third party may receive a portion of queue-swapping transaction proceeds. In yet another implementation, a party may place orders while waiting in the queue. For example, after a party inputs a phone number, the system may send a link to enable the party to order ahead of seating.

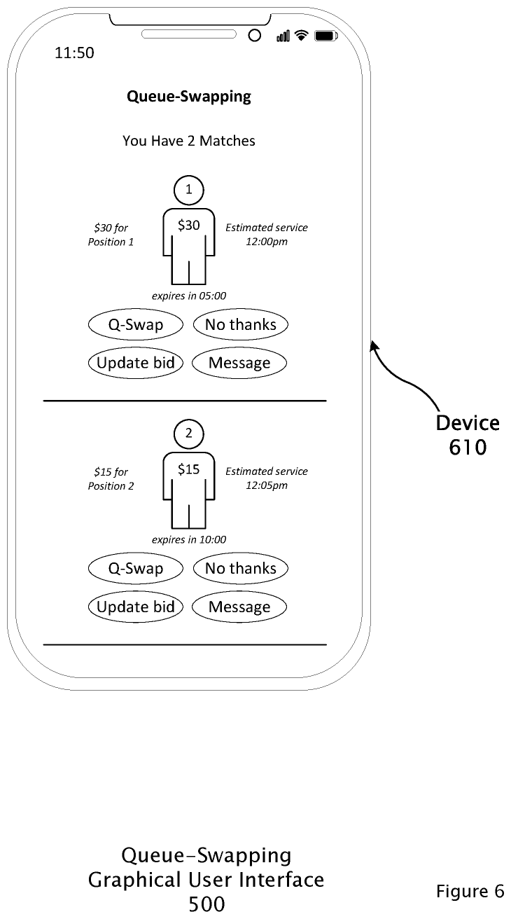

FIG. 6 is an example of a graphical user interface which may be used for queue-swapping, according to one implementation. Device 610 may comprise a mobile device operable to run a queue-swapping software application that displays the queue-swapping GUI. The GUI may include buttons to allow a candidate to accept and execute queue-swapping, to decline, to update a bid, or to message another candidate or an establishment, for example.

In one implementation, queue-swapping may access a database of a social networking platform to retrieve information regarding a waiting party, queue-swapping candidate, an establishment, or other information. For example, it may receive information regarding a party's mobile check-ins or online reviews at an establishment.

Weighted values representing queue-swapping optimization factors may be applied at any step of the queue-swapping process. For example, it may be applied during a step of detecting whether a party should serve as a queue-swapping candidate based on weighted values or during the step of ranking matched candidates. Factors may include, but are not limited to, a queue length, a time constraint, a party's queue-swapping history, high traffic periods, holidays, an average time spent at an establishment, a party's reason for a visit, a party's order history, an indicated level of hunger or urgency, a party's online reviews of an establishment, and a party's demographical data.

Application of the queue-optimization factors may improve efficiency of queue management systems by decreasing lag time between service, for example, by reducing time spent waiting for parties who fail to timely show up when their turn arrives, or who have let a queue out of frustration without notifying a host or queue manager. It may also increase service quality and customer satisfaction, for example, by allowing an establishment to offer rewards to parties who swap positions with a party who has a higher stake in affecting the establishment's business or reputation. For example, an establishment may invite a candidate to swap queue positions with a renowned food critic and offer the surrendering candidate an in-store credit, to increase customer satisfaction and loyalty.

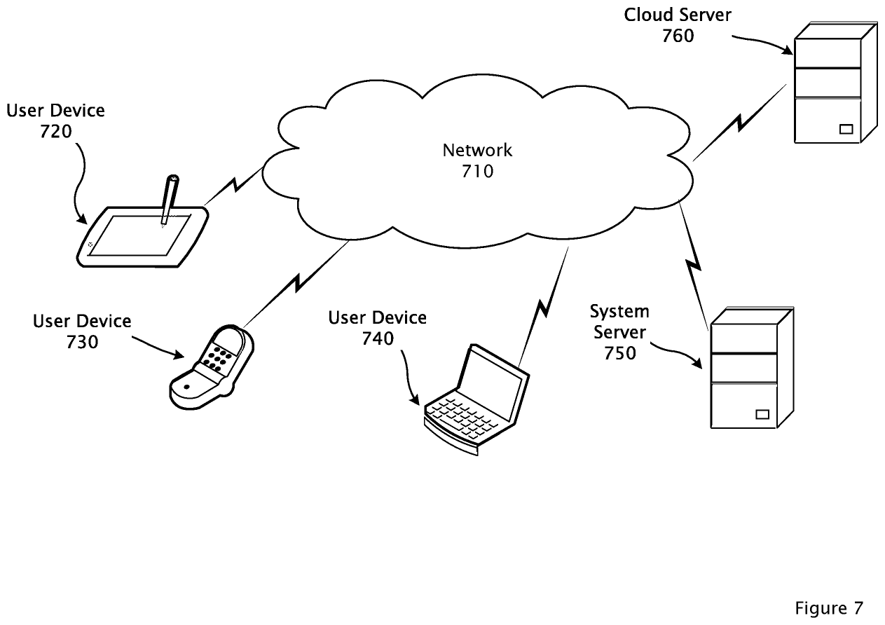

FIG. 7 is a block diagram illustrating an example of a system capable of supporting a queue-swapping method, according to one implementation. Network 710 may include WI-FI wireless networking, cellular data access methods, such as 3G or 4GLTE, BLUETOOTH low-power wireless connectivity technology, Near Field Communications (NFC), Ethernet connectivity, fiber optic connections, the internet, local area networks, wide area networks, or any combination of these or other means of providing data transfer capabilities.

User Device 720, 730, or 740 may have network capabilities to communicate with System Server 750 or Cloud Server 760. System Server 750 or Cloud Server 760 may each include one or more computers and may serve a number of roles. System Server 750 or Cloud Server 760 may be conventionally constructed or may be of a special purpose design for processing data obtained from Queue-Swapping. One skilled in the art will recognize that System Server 750 or Cloud Server 760 may be of many different designs and may have different capabilities.

One having skill in the art will recognize that various configurations for User Device 720, 730, or 740 and System Server 750 or Cloud Server 760 may be used to implement Queue-Swapping.

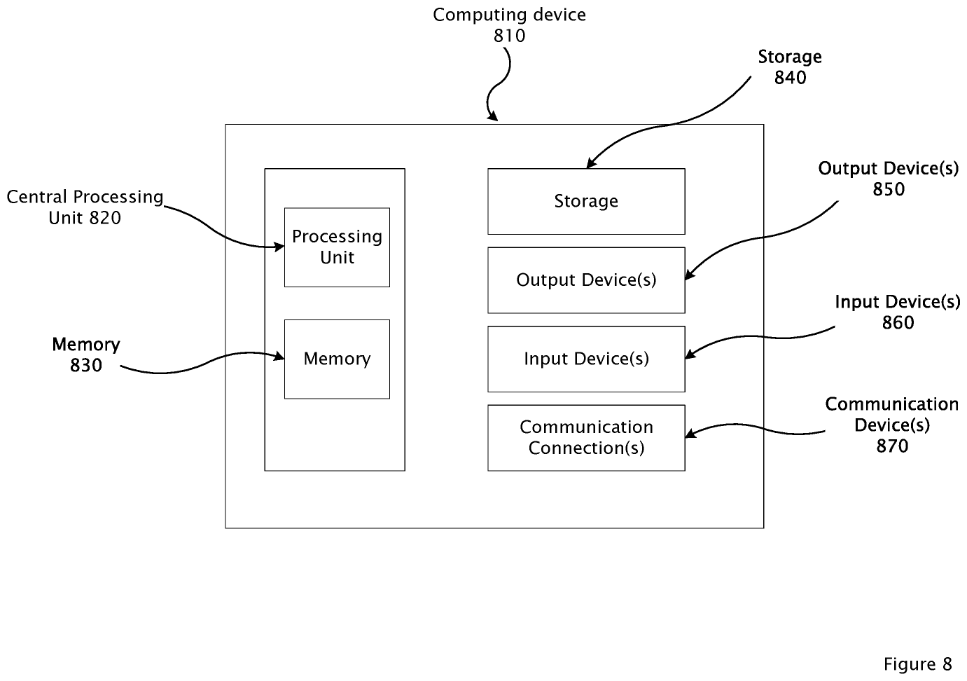

FIG. 8 is a component diagram of a computing device which may support a queue-swapping method, according to one implementation.

Computing Device 810 can be utilized to implement one or more computing devices, computer processes, or software modules described herein, including, for example, but not limited to a mobile device. In one example, Computing Device 810 can be used to process calculations, execute instructions, and receive and transmit digital signals. In another example, Computing Device 810 can be utilized to process calculations, execute instructions, receive and transmit digital signals, receive and transmit search queries and hypertext, and compile computer code suitable for a mobile device. Computing Device 810 can be any general or special purpose computer now known or to become known capable of performing the steps or performing the functions described herein, either in software, hardware, firmware, or a combination thereof.

In its most basic configuration, Computing Device 810 typically includes at least one Central Processing Unit (CPU) 820 and Memory 830. Depending on the exact configuration and type of Computing Device 810, Memory 830 may be volatile (such as RAM), non-volatile (such as ROM, flash memory, etc.) or some combination of the two. Additionally, Computing Device 810 may also have additional features/functionality. For example, Computing Device 810 may include multiple CPU's. The described methods may be executed in any manner by any processing unit in Computing Device 810. For example, the described process may be executed by both multiple CPUs in parallel.

Computing Device 810 may also include additional storage (removable or non-removable) including, but not limited to, magnetic or optical disks or tape. Such additional storage is illustrated by Storage 840. Computer-readable storage media includes volatile and nonvolatile, removable and non-removable media implemented in any method or technology for storage of information such as computer-readable instructions, data structures, program modules or other data. Memory 830 and Storage 840 are all examples of computer-readable storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 810. Any such computer-readable storage media may be part of Computing Device 810. But computer-readable storage media does not include transient signals.

Computing Device 810 may also contain Communications Device(s) 870 that allow the device to communicate with other devices. Communications Device(s) 870 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 810 may also have Input Device(s) 860 such as a keyboard, mouse, pen, voice input device, touch input device, etc. Output Device(s) 850 such as a display, speakers, printer, etc. may also be included. All these devices are well-known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described implementations may be made without departing from the spirit and scope of the invention.

Additionally, the illustrated operations in the description show certain events occurring in a certain order. In alternative implementations, certain operations may be performed in a different order, modified or removed. Moreover, steps may be added to the above-described logic and still conform to the described implementations. Further, operations described herein may occur sequentially, or certain operations may be processed in parallel. Yet further operations may be performed by a single processing unit or by distributed processing units.

1. A queue-swapping method, comprising the steps of:
receiving a request from a first party to enter a queue;
assigning to the first party a first queue position;
determining whether the first party is a queue-swapping candidate;
identifying the first party as a queue-swapping candidate or, alternatively, as a queue-swapping non-participant;
receiving a request from a second party to enter the queue;
assigning to the second party a second queue position;
determining whether the second party is a queue-swapping candidate;
identifying the second party as a queue-swapping candidate or, alternatively, as a queue-swapping non-participant; and
populating a graphical user interface with information regarding queue-swapping candidates.

2. The queue-swapping method of claim 1, further comprising the steps of:
receiving an input value from a first queue-swapping candidate;
receiving an input value from a second queue-swapping candidate;
populating the graphical user interface with input values from the first and second queue-swapping candidates;
identifying a first set of queue-swapping candidates that matches a preference set from the first queue-swapping candidate; whereby a match is determined by comparing the input value from the first queue-swapping candidate and the input value from the second queue-swapping candidate to find compatible or matching values;
filtering or ranking the first set of matched queue-swapping candidates populating the graphical user interface with information regarding the ranked first set of matches;
requesting confirmation to accept a queue swap based on a match, decline a queue swap based on a match, or input an updated value;
receiving responses;
maintaining queue positions if either the first or the second queue-swapping candidate declined the confirmation;
receiving an input value from either the first or the second swapping candidate, if the candidate declined a swap and requested to input an updated value;
executing queue-swapping based on the match for the first and the second queue-swapping candidates who accepted the confirmation to execute the swap based on the match;
updating queue positions;
processing payments or rewards for queue-swapping; and
providing a service for which the queue was entered.

3. The queue-swapping method of claim 1, further comprising applying a set of weighted values for queue-optimization factors.

4. The queue-swapping method of claim 3, wherein the queue-optimizing factors are selected from the list containing a queue length, a time constraint, a party's queue-swapping history, high traffic periods, holidays, an average time spent at an establishment, a party's reason for a visit, a party's order history, an indicated level of hunger or urgency, a party's online reviews of an establishment, and a party's demographical data.

5. The queue-swapping method of claim 2, wherein the service provided is selected from the list containing provision of food, provision of beverages, provision of entertainment, provision of social services, provision of medical care, provision of technical support, and provision of customer service.

6. A computer-implemented system, comprising:
a processor;
a database, the database operable to store a plurality of data about parties entered into a queue;
an application programming interface (API) server operable to receive information that identifies a subset of parties that is available to serve as candidates for queue-swapping;
an identification module operable to generate a set of queue-swapping candidates;
a queue-swapping match identification module operable to generate a set of matched queue-swapping candidates;
a graphical user interface generation module operable to generate a graphical user interface screen which includes information regarding queue-swapping candidates.

6. The computer-implemented system of claim 6, wherein the graphical user interface generation module generates a graphical user interface comprising a queue position, a party name, a party size, an estimated wait time or service time, input values such as a bid amount, queue position, or expiration time, or an input value description, wherein the identification module is further operable to monitor the set of candidates and notify a first party of any changes to the set of candidates.
